(19) United States
(12) Patent Application Publication
(10) Pub. No.: US 2024/0212421 A1
(43) Pub. Date: Jun. 27, 2024

(54) GRAPHICAL USER INTERFACE FOR VISUALIZATION OF GAMING DEVICE NETWORK

(71) Applicant: IGT, Las Vegas, NV (US)

(72) Inventors: Dwayne NELSON, Las Vegas, NV (US); Robert WALKER, Wakefield, RI (US); Bradley BOUDREAU, Moncton (CA); Andrew LEBLANC, Stratford (CA)

(21) Appl. No.: 18/087,478

(22) Filed: Dec. 22, 2022

(51) Int. Cl. G07F 17/32

(52) U.S. Cl. CPC G07F 17/3211; G07F 17/3223

(57) ABSTRACT

A display device of a computing device displays a graphical user interface (GUI) including a system path area including a depiction of a first hierarchy path including a top level of a hierarchy of a plurality of gaming devices, a first sub-level of the hierarchy, and a plurality of nested sub-levels of the hierarchy therebetween. The GUI further includes an object group area including depictions of a first plurality of objects in the first sub-level, each object including one of a gaming device in the first sub-level; and a sub-level below the first sub-level. In response to receipt of an alert condition indication relating to a first gaming device in an alert condition, a depiction is displayed of an alert relating to a first object of the first plurality of objects, including the first gaming device or a second sub-level containing the first gaming device in the alert condition.

### BACKGROUND

Embodiments described herein relate to electronic gaming machines (EGMs), and in particular to a graphical user interface (GUI) for visualization of an EGM or gaming device network, and related systems, devices, and methods. An EGM network in a gaming environment, such as a casino environment, include EGMS in many different locations and in different types of hardware and software configurations, and may vary from casino to casino and market to market for example. Software for managing EGM networks may not allow for efficient and timely notification and tracking of EGM statuses, such as error conditions, playable states, and other criteria for maintaining the network. Thus, there is a need to provide a software solution that allows for more efficient and effective visualization of EGM networks.

### SUMMARY

According to some embodiments, a system includes a processor circuit and a memory including machine-readable instructions. When executed by the processor circuit, the instructions cause the processor circuit to cause a display device of a computing device to display a graphical user interface (GUI) including a system path area comprising a depiction of a first hierarchy path comprising a top level of a hierarchy of a plurality of gaming devices, a first sub-level of the hierarchy, and a plurality of nested sub-levels of the hierarchy between the top level and the first sub-level. The GUI further includes an object group area comprising depictions of a first plurality of objects in the first sub-level of the hierarchy, each object of the first plurality of objects comprising one of a gaming device in the first sub-level; and a sub-level below the first sub-level. The instructions further cause the processor circuit to, in response to receipt of an alert condition indication relating to a first gaming device of the plurality of gaming devices in an alert condition, cause the display device to display a depiction of an alert relating to a first object of the first plurality of objects, the first object comprising one of the first gaming device in the alert condition; and a second sub-level below the first sub-level containing the first gaming device in the alert condition.

According to some embodiments, a computer device includes a display device, an input device, a processor circuit, and a memory including machine-readable instructions. When executed by the processor circuit, the instructions cause the processor circuit to display, by the display device, a graphical user interface (GUI) comprising a system path area comprising a depiction of a first hierarchy path comprising a top level of a hierarchy of a plurality of gaming devices, a first sub-level of the hierarchy, and a plurality of nested sub-levels of the hierarchy between the top level and the first sub-level. The GUI further includes an object group area comprising depictions of a first plurality of objects in the first sub-level of the hierarchy, each object of the first plurality of objects comprising one of a gaming device in the first sub-level; and a sub-level below the first sub-level. The instructions further cause the processor circuit to, in response to receipt of an alert condition indication relating to a first gaming device of the plurality of gaming devices in an alert condition, display, by the display device, a depiction of an alert relating to a first object of the first plurality of objects, the first object comprising one of the first gaming device in the alert condition; and a second sub-level below the first sub-level containing the first gaming device in the alert condition.

According to some embodiments, a method includes displaying, by a display device of a computing device, a graphical user interface (GUI) comprising a system path area comprising a depiction of a first hierarchy path comprising a top level of a hierarchy of a plurality of gaming devices, a first sub-level of the hierarchy, and a plurality of nested sub-levels of the hierarchy between the top level and the first sub-level. The GUI further includes an object group area comprising depictions of a first plurality of objects in the first sub-level of the hierarchy, each object of the first plurality of objects comprising one of a gaming device in the first sub-level; and a sub-level below the first sub-level. The method further includes receiving an alert indication relating to a first gaming device of the plurality of gaming devices in an alert condition. The method further includes, in response to receiving the alert indication, displaying, by the display device, a depiction of an alert relating to a first object of the first plurality of objects, the first object comprising one of the first gaming device in the alert condition; and a second sub-level below the first sub-level containing the first gaming device in the alert condition.

### BRIEF DESCRIPTION OF THE DRAWINGS

FIG. 1 is a schematic block diagram illustrating a network configuration for a plurality of gaming devices according to some embodiments.

FIGS. 2A to 2E illustrate gaming devices according to various embodiments.

FIGS. 3A-3D are views of a graphical user interface (GUI) of a computer system for visualizing an EGM network, according to some embodiments.

FIGS. 4A-4C are alternate views of a graphical user interface (GUI) of a computer system for visualizing an EGM network, according to some embodiments.

FIG. 5 is a flowchart illustrating operations of systems/methods according to some embodiments.

### DETAILED DESCRIPTION

Embodiments described herein relate to electronic gaming machines (EGMs), and in particular to a graphical user interface (GUI) for visualization of an EGM or gaming device network, and related systems, devices, and methods. For example, in some embodiments, a display device of a computing device displays a graphical user interface (GUI) including a system path area including a depiction of a first hierarchy path including a top level of a hierarchy of a plurality of gaming devices, a first sub-level of the hierarchy, and a plurality of nested sub-levels of the hierarchy therebetween. The GUI further includes an object group area including depictions of a first plurality of objects in the first sub-level, each object including one of a gaming device in the first sub-level; and a sub-level below the first sub-level. In response to receipt of an alert condition indication relating to a first gaming device in an alert condition, a depiction is displayed of an alert relating to a first object of the first plurality of objects, including the first gaming device or a second sub-level containing the first gaming device in the alert condition.

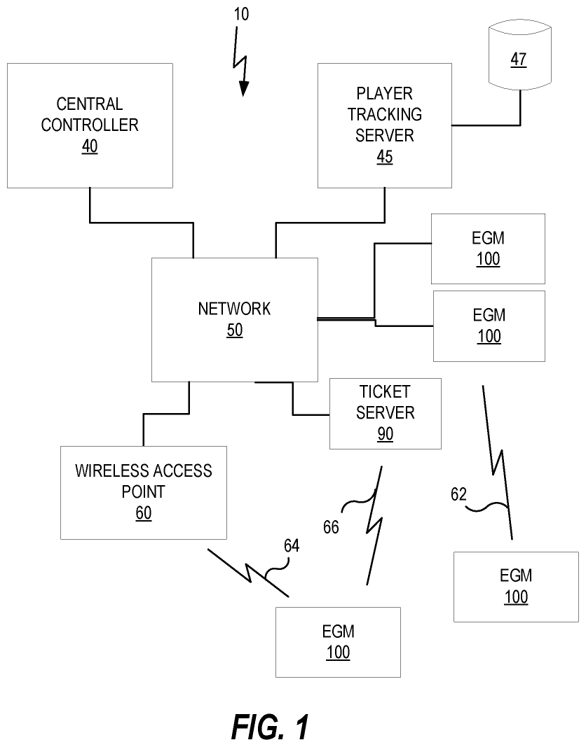

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

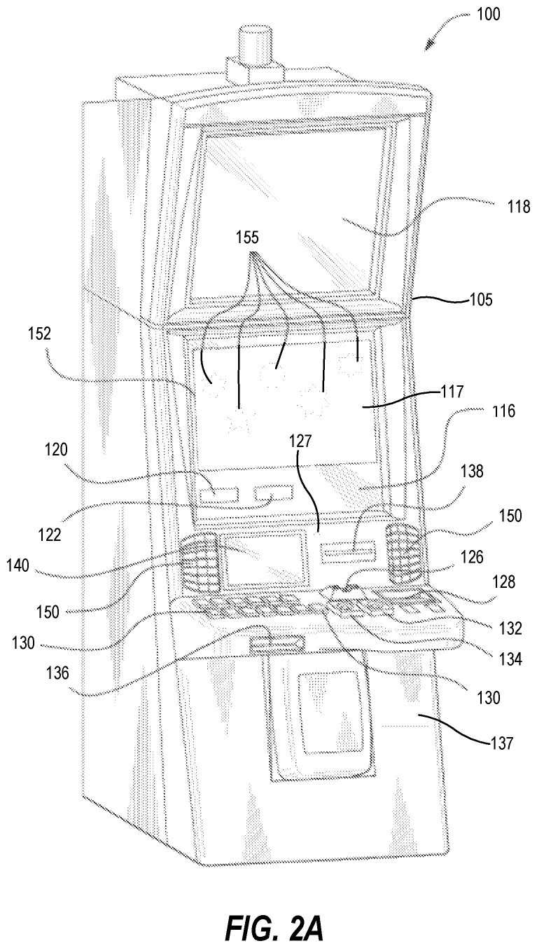

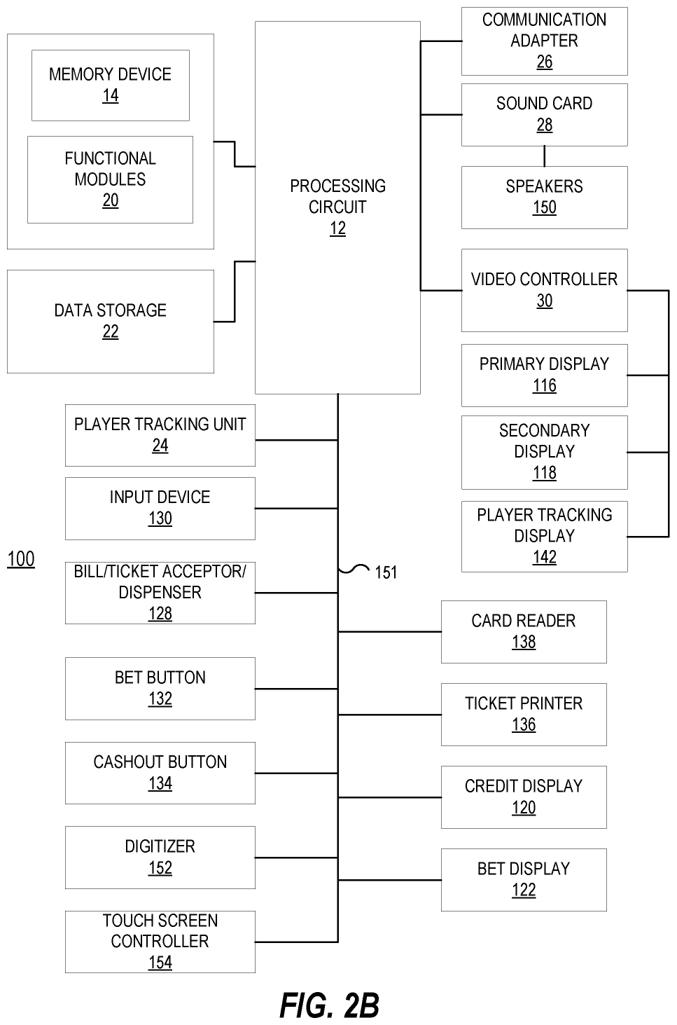

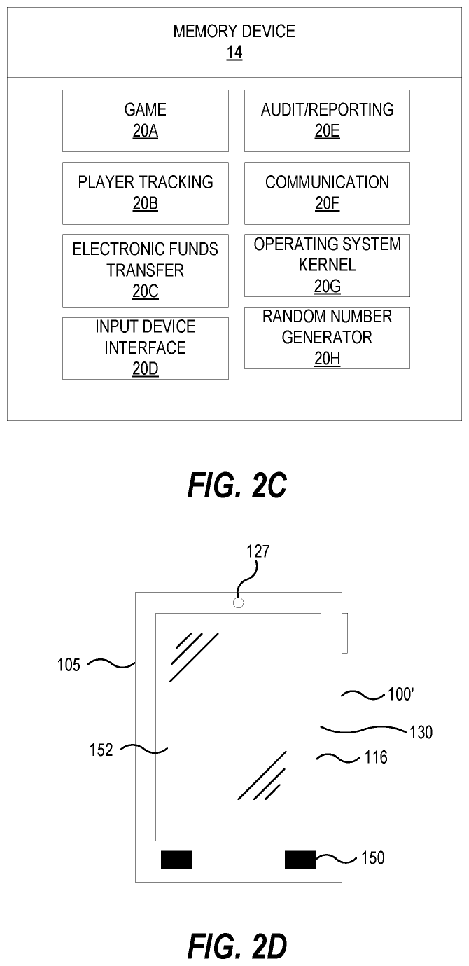

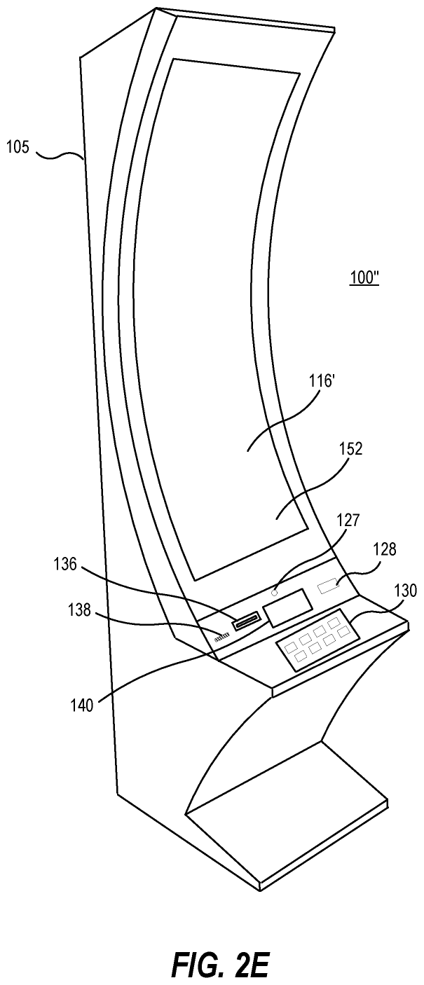

Embodiments herein may include different types of gaming devices. Various embodiments are illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A and 2B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100′ may be implemented as a handheld device including a compact housing 105 on which is mounted a touchscreen display device 116 including a digitizer 152. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

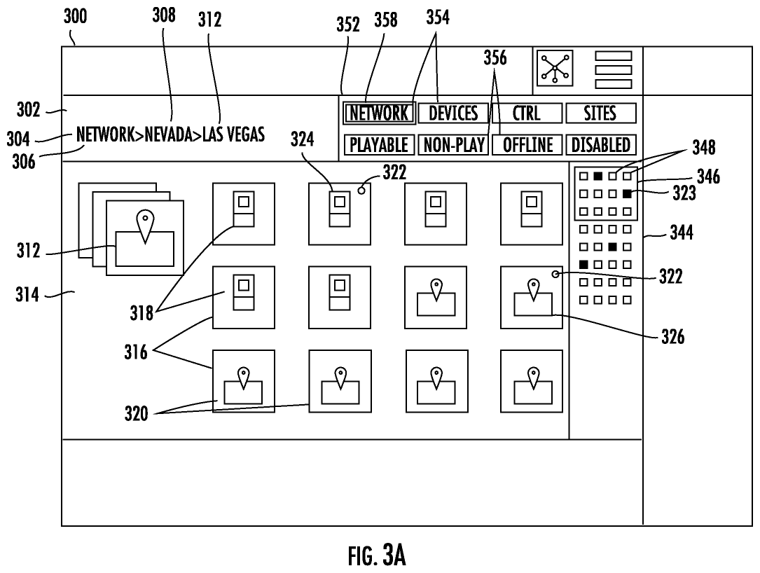

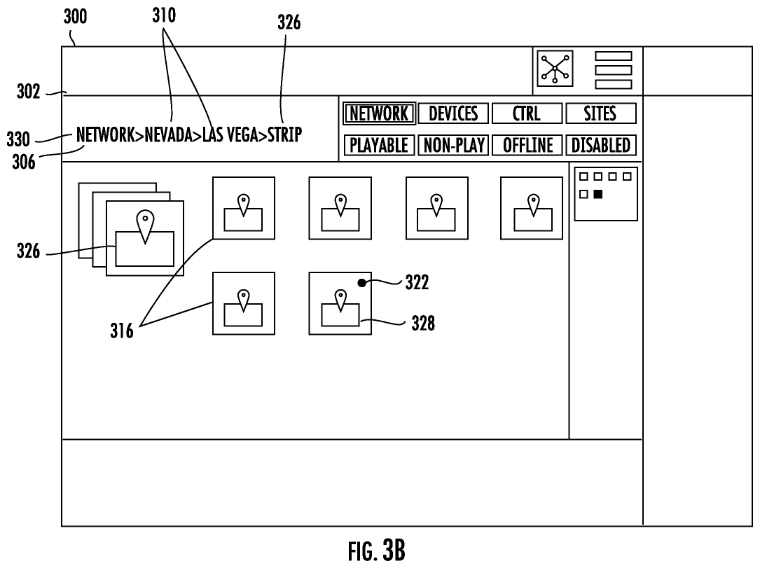

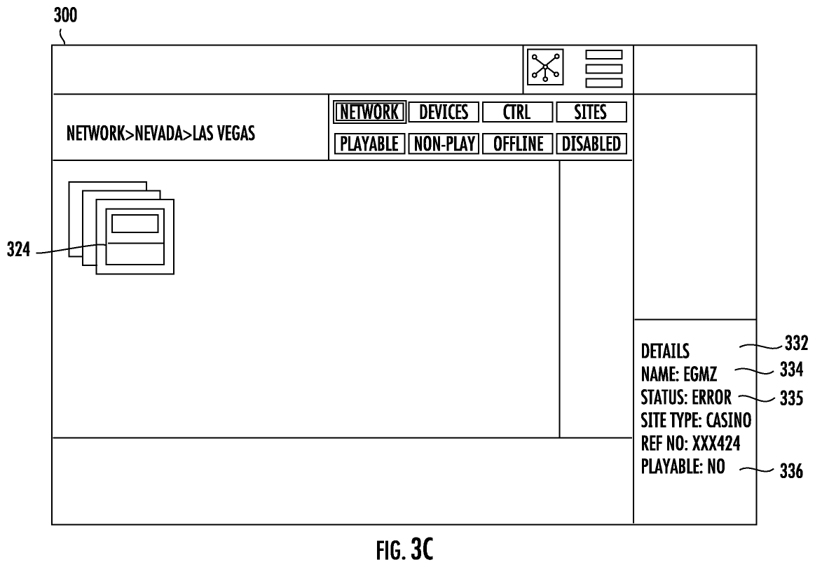

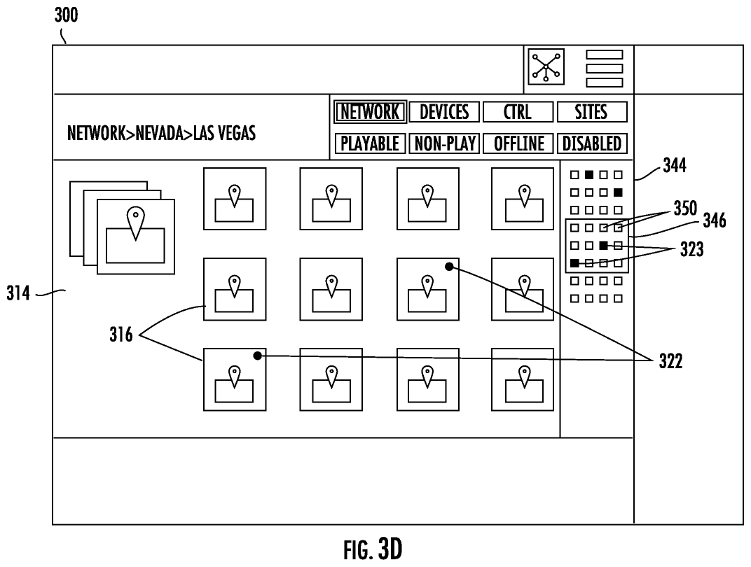

In this regard, FIGS. 3A-3D illustrate a graphical user interface (GUI) 300 for visualization of a gaming device network. The GUI 300 includes a system path area 302 including a depiction of a hierarchy path 304, which includes a top level 306 of a gaming device hierarchy 308 and a plurality of nested sub-levels 310 of the hierarchy between the top level and a selected sub-level 312.

As shown by FIG. 3A, the GUI 300 includes an object group area 314 including depictions of a plurality of objects 316 in the selected sub-level 310 of the hierarchy 308. In this example, each object 316 represents either a EGMs 318 in the selected sub-level 312, or another sub-level 320 nested below the selected sub-level 312.

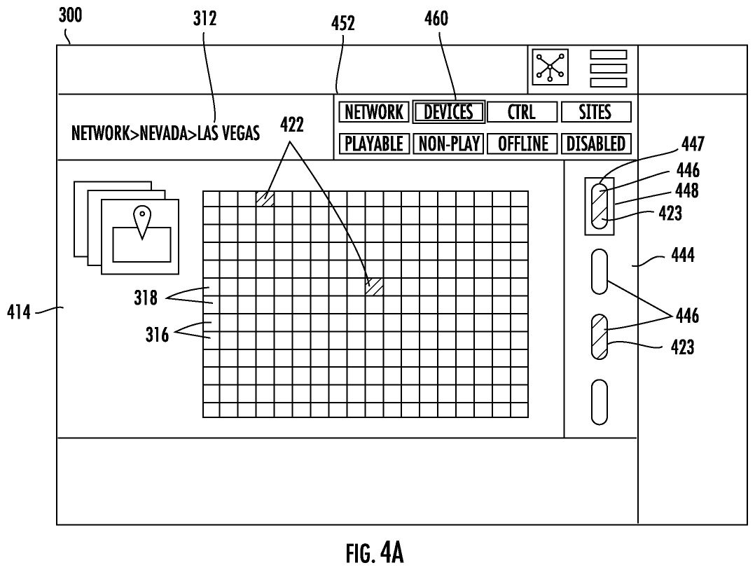

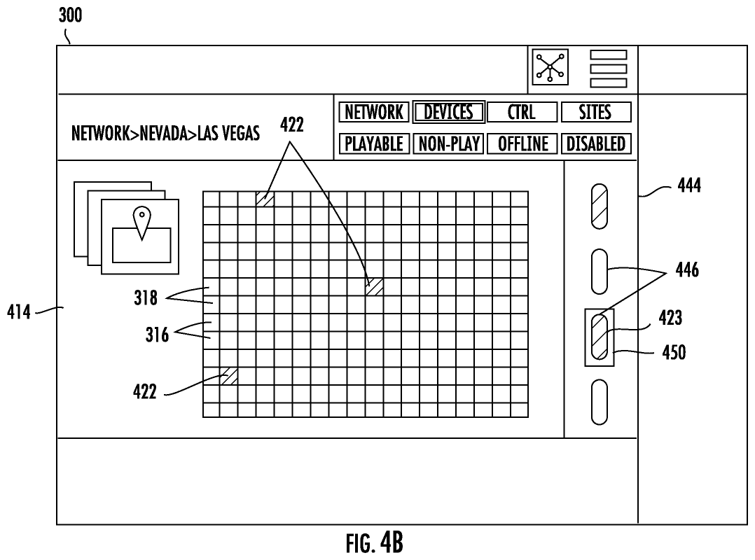

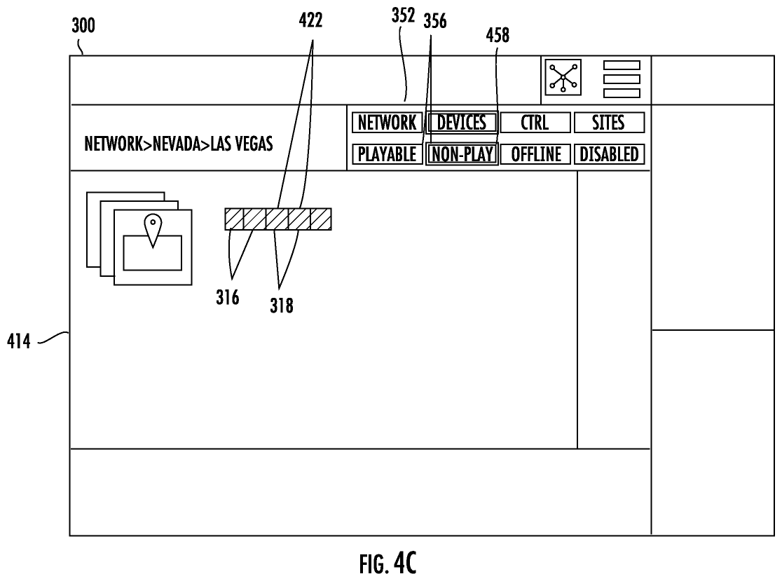

In this example, the system monitors the EGMs 318 in all or a portion of the gaming device hierarchy 308. In response to receipt of an alert condition indication relating to one of the EGMs 318 being in an alert condition, the GUI 300 displays a depiction of an alert 322 associated with one of the objects 316 in the object group area 314. For example, for an alert condition relating to a particular gaming device 324 in the first sub-level 312 being displayed in the object group area 314, an alert 322 is depicted in association with the particular gaming device 324. For an alert condition relating to a EGMs 318 in a sub-level 310 nested below the selected sub-level 312 via a particular sub-level 326 being displayed in the object group area 314, an alert 322 is depicted in association with the particular sub-level 326. As will be described in greater detail below with respect to FIGS. 4A-4C, the GUI 300 also includes an object filter area 352 with one or more selectable view criteria 354 for modifying a view of the GUI 300 and one or more selectable filter criteria 356 for filtering the display of objects 316 in the GUI 300.

As shown by FIG. 3B, in response to a user input associated with the particular sub-level 326 containing a gaming device in an alert condition, e.g., selection of the particular sub-level 326 in the GUI 300, the GUI 300 may modify the object group area 314 to display depictions of a second plurality of objects 316 in the particular sub-level 326. The particular sub-level 326 may include another gaming device 318 in an alert condition, and/or additional nested sub-levels 328 which contain one or more gaming devices in an alert condition, which are each indicated by an appropriate alert 322 depiction. The system path area 302 may also be modified to display a depiction of a modified hierarchy path 330 including the top level 306 of the hierarchy 308, the particular sub-level 326 of the hierarchy 308, and a plurality of nested sub-levels 310 between the top level 306 and the particular sub-level 326.

As shown by FIG. 3C, in response to a user input associated with the particular gaming device 324 in the alert condition, e.g., selection of the particular gaming device 324 in the GUI 300, the GUI 300 may display a depiction of the particular gaming device 324. The GUI 300 may also display a depiction of information 332 associated with the particular gaming device 324. For example, the information 332 may include identifying information 334 for the particular gaming device 324, identifying information 335 for the alert condition, and/or an indication 336 of a playability state for the particular gaming device 324, e.g., whether the particular gaming device 324 is in a playable or unplayable state. Similar information may also be displayed in response to selection of the particular sub-level 326 containing a gaming device in an alert condition, as desired. The information 338 may include similar information as the information 332 associated with the particular gaming device 324, and may also include an indication of a hierarchy path associated with the gaming device in an alert condition associated with the particular sub-level 326.

In some embodiments, the number of objects 316 in a particular sub-level may be too large to display each object 316 individually within the object group area 314. In this regard, referring back to FIG. 3A, the GUI 300 may further include an object group overview area 344 including depictions of another plurality of objects in the selected sub-level 312 of the hierarchy 308. The object group overview area 344 may include a graphical area indication 346 including a subset 348 of objects 316 corresponding to the plurality of objects 316 displayed in the object group area 314. The objects 316 within the object group overview area 344 may also include alert indications 323 corresponding to EGMs in an alert condition to allow for efficient navigation to EGMs in need of attention.

As shown by FIG. 3D, in response to a user input associated with a second subset 350 of objects in the object group overview area 344, the graphical area indication 346 is modified to include the second subset 350 of objects, and the object group area 314 is similarly modified to display depictions of the second subset 350 of objects 316.

As discussed above, the GUI 300 also includes an object filter area 352 with one or more selectable view criteria 354 for modifying a view of the GUI 300 and one or more selectable filter criteria 356 for filtering the display of objects 316 in the GUI 300. In this regard, a network view 358 is selected in FIGS. 3A-3D for viewing and locating EGMs 318 in a network hierarchy.

Referring now to FIG. 4A, a device view 460 of the GUI 300 is selected, which includes an alternate object group area 414 and an alternate object group overview area 444, which may be used for management of large numbers of EGMs 318, which may scale into the thousands for some operators, without reference to the locations of the objects 316 within the overall network. In this example, the object group area 414 includes a plurality of smaller objects 316 corresponding to a subset 448 of EGMs 318 in the selected sub-level 312 and all nested sub-levels therein, to provide a more generalized overview of a larger portion of the EGM network, while allowing for efficient identification of EGMs 318 in need of attention. For example, in this example, the object group overview area includes a plurality of graphical area indications 446 corresponding to the selected subset 448 and additional subsets of the entire selected group of EGMs 318. In this example, any EGM 318 in the object group area 414 in an alert condition includes an alert indication 422, and any graphical area indication 446 corresponding to a subset of EGMs that contains an EGM 318 in an alert condition also contains an alert indication 423 to allow for efficient navigation to EGMs 318 in need of attention.

As shown by FIG. 4B, in response to a user input associated with a second subset 450 of objects in the object group overview area 444, the graphical area indication 446 is modified to include the second subset 450 of objects 316, and the object group area 414 is similarly modified to display depictions of the second subset 450 of objects 316.

In some embodiments, it may be desirable to apply additional filters to the display of the objects 316 to only display objects 316 that are relevant to a particular workflow, e.g., troubleshooting error conditions, determining operational states of gaming devices, etc. In this regard, as discussed above, the object filter area 352 may include one or more selectable filter criteria 356 for filtering the display of objects 316 in the GUI 300.

As shown by FIG. 4C, in response to a user input associated with a filter condition, an indication 458 of the filter condition may be displayed in the object filter area 452, and the object group area 414 and/or object group overview area 444 may be modified to remove depictions of a subset of the objects 316 not corresponding to the filter condition, such that only objects 316 corresponding to the filter condition are displayed. In this example, the filter condition is directed to isolating non-playable EGMs 318 across the entire network. In some embodiments, the objects 316 may be reordered in the object group area 414 and/or object group overview area 444 to group the objects 316 corresponding to the filter condition together, and/or may dim or otherwise modify the depiction of the objects 316 not corresponding to the filter condition in the object group area 414 and/or object group overview area 344 to deemphasize the objects 316 not corresponding to the filter condition.

In response to a user input associated with removal of the filter condition, the object filter area 352 may be cleared of the indication 458 of FIG. 4C, and the object group area 414 may be modified to restore the depictions of the objects 316 not corresponding to the filter condition.

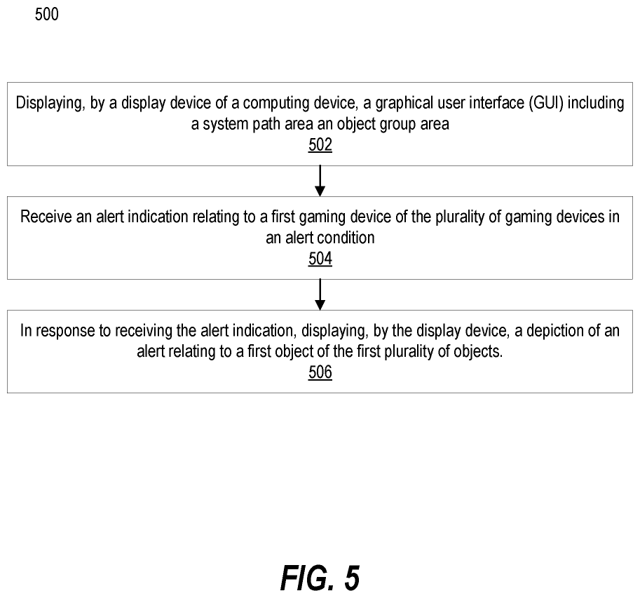

FIG. 5 illustrates a flowchart of operations 500 of systems/methods for visualization of a gaming device network, according to some embodiments. The operations 500 may include displaying, by a display device of a computing device, a graphical user interface (GUI) including a system path area an object group area (Block 502). For example, the system path area may include a depiction of a first hierarchy path including a top level of a hierarchy of a plurality of gaming devices, a first sub-level of the hierarchy, and a plurality of nested sub-levels of the hierarchy between the top level and the first sub-level, similar to the arrangement described above with respect to FIGS. 3A-4C. The object group area may include depictions of a first plurality of objects in the first sub-level of the hierarchy, each object of the first plurality of objects including one of a gaming device in the first sub-level, and a sub-level below the first sub-level, similar to the arrangement described above with respect to FIGS. 3A-4C.

The operations 500 may further include receiving an alert indication relating to a first gaming device of the plurality of gaming devices in an alert condition (Block 504). The operations 500 may further include, in response to receiving the alert indication, displaying, by the display device, a depiction of an alert relating to a first object of the first plurality of objects (Block 506). In some examples, the first object may include one of the first gaming device in the alert condition, and a second sub-level below the first sub-level containing the first gaming device in the alert condition, similar to the arrangement described above with respect to FIGS. 3A-4C.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
cause a display device of a computing device to display a graphical user interface (GUI) comprising:
a system path area comprising a depiction of a first hierarchy path comprising a top level of a hierarchy of a plurality of gaming devices, a first sub-level of the hierarchy, and a plurality of nested sub-levels of the hierarchy between the top level and the first sub-level; and
an object group area comprising depictions of a first plurality of objects in the first sub-level of the hierarchy, each object of the first plurality of objects comprising one of:
a gaming device in the first sub-level; and
a sub-level below the first sub-level; and
in response to receipt of an alert condition indication relating to a first gaming device of the plurality of gaming devices in an alert condition, cause the display device to display a depiction of an alert relating to a first object of the first plurality of objects, the first object comprising one of:
the first gaming device in the alert condition; and
a second sub-level below the first sub-level containing the first gaming device in the alert condition.

2. The system of claim 1, wherein the instructions further cause the processor circuit to:
in response to a user input associated with the first object, cause the display device to display a depiction of the first gaming device in the alert condition.

3. The system of claim 2, wherein the instructions to display a depiction of the first gaming device in the alert condition further cause the processor circuit to:
modify the object group area to display depictions of a second plurality of objects in the second sub-level comprising the first gaming device in the alert condition.

4. The system of claim 3, wherein the instructions to display a depiction of the first gaming device in the alert condition further cause the processor circuit to:
modify the system path area to display a depiction of a second hierarchy path comprising the top level of the hierarchy, the second sub-level of the hierarchy, and the plurality of nested sub-levels of the hierarchy between the top level and the second sub-level.

5. The system of claim 1, wherein the instructions further cause the processor circuit to:
in response to a user input associated with the first object, display a depiction of information associated with the first gaming device.

6. The system of claim 5, wherein the information associated with the first gaming device comprises identifying information for the first gaming device.

7. The system of claim 5, wherein the information associated with the first gaming device comprises identifying information for the alert condition.

8. The system of claim 5, wherein the information associated with the first gaming device comprises an indication of a playability state for the first gaming device.

9. The system of claim 5, wherein the information associated with the first gaming device comprises an indication of a second hierarchy path comprising the first sub-level in the hierarchy and the second sub-level of the hierarchy.

10. The system of claim 1, wherein the GUI further comprises an object group overview area comprising:
depictions of a second plurality of objects in the first sub-level of the hierarchy, each object of the second plurality of objects comprising one of:
a gaming device in the first sub-level; and
a sub-level below the first sub-level; and
a graphical area indication comprising a first subset of objects of the second plurality of objects, the first subset of objects corresponding to the first plurality of objects displayed in the object group area.

11. The system of claim 10, wherein the instructions further cause the processor circuit to, in response to a user input associated with a second subset of objects of the second plurality of objects:
modify the graphical area indication to comprise the second subset of objects; and
modify the object group area to display depictions of the second subset of objects.

12. The system of claim 10, wherein the instructions further cause the processor circuit to display a depiction of the alert relating to the first object in the object group overview area.

13. The system of claim 10, wherein the GUI further comprises an object filter area, and
wherein the instructions further cause the processor circuit to, in response to a user input associated with a filter condition:
display an indication of the filter condition in the object filter area;
modify the object group area to remove depictions of a first subset of the first plurality of objects not corresponding to the filter condition; and
modify the object group overview area to remove depictions of a second subset of the first plurality of objects not corresponding to the filter condition.

14. The system of claim 1, wherein the GUI further comprises an object filter area, and
wherein the instructions further cause the processor circuit to, in response to a user input associated with a filter condition:
display an indication of the filter condition in the object filter area; and
modify the object group area to modify depictions of a first subset of the first plurality of objects not corresponding to the filter condition.

15. The system of claim 14, wherein the instructions to modify the object group area further cause the processor circuit to remove depictions of the first subset of the first plurality of objects.

16. The system of claim 14, the instructions further cause the processor circuit to, in response to a user input associated with removal of the filter condition:
remove the indication of the filter condition in the object filter area; and
modify the object group area to restore the depictions of the first subset of the first plurality of objects not corresponding to the filter condition.

17. A computer device comprising:
a display device;
an input device;
a processor circuit; and
a memory comprising machine-readable instructions that, when executed by the processor circuit, cause the processor circuit to:
display, by the display device, a graphical user interface (GUI) comprising:
a system path area comprising a depiction of a first hierarchy path comprising a top level of a hierarchy of a plurality of gaming devices, a first sub-level of the hierarchy, and a plurality of nested sub-levels of the hierarchy between the top level and the first sub-level; and
an object group area comprising depictions of a first plurality of objects in the first sub-level of the hierarchy, each object of the first plurality of objects comprising one of:
a gaming device in the first sub-level; and
a sub-level below the first sub-level; and
in response to receipt of an alert condition indication relating to a first gaming device of the plurality of gaming devices in an alert condition, display, by the display device, a depiction of an alert relating to a first object of the first plurality of objects, the first object comprising one of:
the first gaming device in the alert condition; and
a second sub-level below the first sub-level containing the first gaming device in the alert condition.

18. The computer device of claim 17, wherein the instructions further cause the processor circuit to:
in response to receipt of a user input by the input device associated with the first object, display, by the display device, a depiction of the first gaming device in the alert condition.

19. A method comprising:
displaying, by a display device of a computing device, a graphical user interface (GUI) comprising:
a system path area comprising a depiction of a first hierarchy path comprising a top level of a hierarchy of a plurality of gaming devices, a first sub-level of the hierarchy, and a plurality of nested sub-levels of the hierarchy between the top level and the first sub-level; and
an object group area comprising depictions of a first plurality of objects in the first sub-level of the hierarchy, each object of the first plurality of objects comprising one of:
a gaming device in the first sub-level; and
a sub-level below the first sub-level;
receiving an alert indication relating to a first gaming device of the plurality of gaming devices in an alert condition; and
in response to receiving the alert indication, displaying, by the display device, a depiction of an alert relating to a first object of the first plurality of objects, the first object comprising one of:
the first gaming device in the alert condition; and
a second sub-level below the first sub-level containing the first gaming device in the alert condition.

20. The method of claim 19, further comprising:
receiving a user input associated with the first object; and
in response to receiving the user input, display, by the display device, a depiction of the first gaming device in the alert condition.
